(19) United States
(12) Patent Application Publication
(10) Pub. No.: US 2017/0171339 A1
(43) Pub. Date: Jun. 15, 2017

(54) ADVERTISEMENT DATA TRANSMISSION METHOD, ELECTRNOIC DEVICE AND SYSTEM

(71) Applicants: Le Holdings (Beijing) Co., Ltd., Beijing (CN); Le Shi Internet Information & Technology Corp., Beijing, Beijing (CN)

(72) Inventors: Jian Cheng, Beijing (CN); Weibo Ao, Beijing (CN)

(73) Assignees: Le Holdings (Beijing) Co., Ltd., Beijing (CN); Le Shi Internet Information & Technology Corp., Beijing, Beijing (CN)

(21) Appl. No.: 15/244,795

(22) Filed: Aug. 23, 2016

Related U.S. Application Data
(63) Continuation of application No. PCT/CN2016/088332, filed on Jul. 4, 2016.

(30) Foreign Application Priority Data
Dec. 10, 2015 (CN) 201510917582.4

(51) Int. Cl. H04L 29/08; H04L 29/06

(52) U.S. Cl. CPC H04L 67/28; H04L 67/42; H04L 67/10; H04L 67/02

(57) ABSTRACT

An advertisement data transmission method, an electronic device, and a system are provided. The system includes: a client establishes a network connection with a proxy server; the client transmits request information for representing a request for acquiring advertisement data to the proxy server; the proxy server transmits the request information to a media asset server; the media asset server generates index information for representing an advertisement data address according to the request information, and transmits the index information to the proxy server; the proxy server transmits the index information to an advertisement server; the advertisement server extracts advertisement data according to the index information, and transmits the advertisement data to the proxy server; and the proxy server transmits the advertisement data to the client.

### CROSS REFERENCE TO RELATED APPLICATIONS

This application is a continuation of International Application No. PCT/CN2016/088332, filed on Jul. 4, 2016, which is based upon and claims priority to Chinese Patent Application No. 201510917582.4, filed on Dec. 10, 2015, the entire contents of which are incorporated herein by reference.

### TECHNICAL FIELD

The disclosure relates to the technical field of communications, and particularly relates to an advertisement data transmission method and an electronic device.

### BACKGROUND

The mobile advertisement business is a technology for putting advertisement information through mobile media. The existing system for supporting the mobile advertisement business is a mobile advertising enabler (MobAd) based on an open mobile alliance (OMA). Based on the system, see FIG. 1, which shows the data transmission sequence diagram of the existing advertising enabler. The data transmission method of the existing advertising enabler comprises: a client transmits related information of a request for acquiring an advertisement (e.g., a video) to a media asset server at first; the client transmits the advertisement-related information to an advertisement server after acquiring the advertisement-related information from the media asset server; and then the advertisement server transmits advertisement data, e.g., a video, to the client according to the received advertisement-related information.

In the prior art, because the data interaction of the client with the media asset server and the advertisement server is often serial, the time consumption for requesting the advertisement is long and the transmission efficiency of the advertisement data is reduced. How to reduce the time consumption for requesting the advertisement for the client becomes a problem to be urgently solved.

### SUMMARY

The disclosure provides an advertisement data transmission method and an electronic device, which can shorten the time consumption for requesting an advertisement and increase the transmission efficiency of the advertisement data.

One objective of the embodiments of the disclosure is to provide an advertisement data transmission method, used for a proxy server side, comprising the steps of:

Establishing network connections with a media asset server and an advertisement server respectively; acquiring request information for representing a request for acquiring advertisement data from the client; transmitting the request information to the media asset server; receiving index information for representing an advertisement data address from the media asset server; transmitting the index information to the advertisement server; and receiving advertisement data extracted by the advertisement server according to the index information, and transmitting the advertisement data to the client.

Another objective of the embodiments of the disclosure is to provide an advertisement data transmission system, comprising a client, a proxy server, a media asset server and an advertisement server, wherein,

The client is used for establishing a network connection with the proxy server and transmitting request information for representing a request for acquiring advertisement data to the proxy server; the proxy server is used for transmitting the request information to the media asset server; the media asset server is used for generating index information for representing an advertisement data address according to the request information, and transmitting the index information to the proxy server; the proxy server is also used for transmitting the index information to the advertisement server; the advertisement server is used for extracting advertisement data according to the index information, and transmitting the advertisement data to the proxy server; and the proxy server is also used for transmitting the advertisement data to the client.

Another objective of the embodiments of the disclosure is to provide an electronic device, used for a proxy server side, comprising: at least one processor; and a memory communicably connected with the at least one processor for storing instructions executable by the at least one processor, wherein execution of the instructions by the at least one processor causes the at least one processor to: establish network connections with a media asset server and an advertisement server respectively; acquire request information for representing a request for acquiring advertisement data from the client; transmit the request information to the media asset server; receive index information for representing an advertisement data address from the media asset server; transmit the index information to the advertisement server; and receive advertisement data extracted by the advertisement server according to the index information, and transmit the advertisement data to the client.

A further objective of the embodiments of the disclosure is to provide a non-transitory computer-readable storage medium, used for a proxy server side, storing executable instructions that, when executed by an electronic device, cause the electronic device to: establish network connections with a media asset server and an advertisement server respectively; acquire request information for representing a request for acquiring advertisement data from the client; transmit the request information to the media asset server; receive index information for representing an advertisement data address from the media asset server; transmit the index information to the advertisement server; and receive advertisement data extracted by the advertisement server according to the index information, and transmit the advertisement data to the client.

A further objective of the embodiments of the disclosure is to provide an electronic device, used for a client, comprising: at least one processor; and a memory communicably connected with the at least one processor for storing instructions executable by the at least one processor, wherein execution of the instructions by the at least one processor causes the at least one processor to: establish a network connection with the proxy server; transmit request information for representing a request for acquiring advertisement data to the proxy server; and receive advertisement data transmitted by the proxy server.

A further objective of the embodiments of the disclosure is to provide a non-transitory computer-readable storage medium, used for a client, storing computer executable instructions that, when executed by an electronic device, cause the electronic device to: establish a network connection with the proxy server; transmit request information for representing a request for acquiring advertisement data to the proxy server; and receive advertisement data transmitted by the proxy server.

In the advertisement data transmission method, the electronic device and the system provided in the embodiments of the disclosure, because the client transmits request information for representing a request for acquiring advertisement data, and index information through a proxy service and then receives advertisement data transmitted by the proxy service when the client has a network connection with a proxy server, as compared with serial data interaction that the client transmits request information and index information to a media asset server and an advertisement server respectively, the time consumption for requesting an advertisement is shortened and the transmission efficiency of the advertisement data is increased.

As an optional technical solution, the proxy server communicates with the media asset server and the advertisement server through a local area network, thereby further increasing the data interaction efficiency.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a data transmission sequence diagram of the existing advertising enabler;

FIG. 2 is a sequence diagram of an advertisement data transmission system in the embodiment of the disclosure;

FIG. 3 is a flow chart of an advertisement data transmission method in the embodiment of the disclosure;

FIG. 4 is a schematic diagram of an advertisement data transmission device in the embodiment of the disclosure;

FIG. 5 is a flow chart of an advertisement data transmission method in the embodiment of the disclosure;

FIG. 6 is a schematic diagram of an advertisement data transmission device in the embodiment of the disclosure;

FIG. 7 is a schematic diagram of the hardware configuration of the electronic device provided by the embodiment of the disclosure, which performs the advertisement data transmission method applied to a proxy server side;

FIG. 8 is a schematic diagram of the hardware configuration of the electronic device provided by the embodiment of the disclosure, which performs the advertisement data transmission method applied to a client;

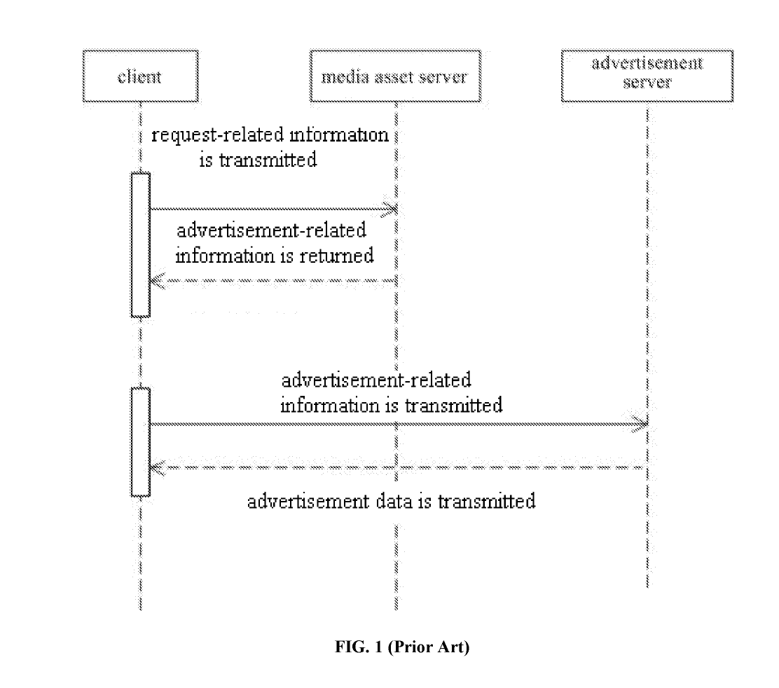

### DETAILED DESCRIPTION

In order to clearly describe objectives, the technical solutions and advantages of the disclosure. A clear and complete description of the technical solutions in the disclosure will be given below, in conjunction with the accompanying drawings in the embodiments of the disclosure. Apparently, the embodiments described below are a part, but not all, of the embodiments of the disclosure.

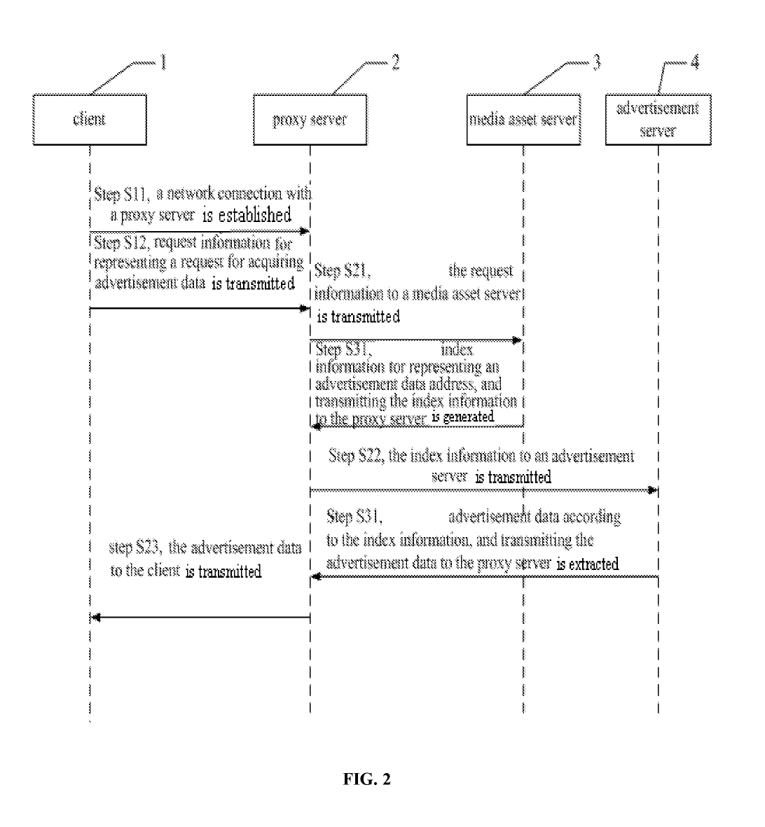

In order to solve the technical problem of long time consumption for requesting an advertisement for a client, the embodiment discloses an advertisement data transmission system which comprises a client 1, a proxy server 2, a media asset server 3 and an advertisement server 4. See FIG. 2, which shows the sequence diagram of the advertisement data transmission system. The advertisement data transmission system comprises:

Step S11, the client 1 establishes a network connection with the proxy server 2; wherein, in the embodiment, the network connection can be a wireless network connection, e.g., WiFi, optical communication connection, etc., or a mobile data network, e.g., CMCC, China Telecom, China Unicom, etc.; of course, in other regions, the network connection can also be a mobile data network of other places;

Step S12, the client 1 transmits request information for representing a request for acquiring advertisement data to the proxy server 2, wherein the request information can come from an application (APP) of the client 1; when an audience user runs a game application or opens a certain web page, the application transmits the request information, wherein the request information can carry one or more advertisement parameters of a user identifier, a business provider identifier or a client identifier, terminal information (such as the type, etc.), context data, an advertisement provider, an advertisement position identifier, an advertisement size, an advertisement dimension, etc;

Step S21, the proxy server 2 transmits the request information to the media asset server 3;

Step S31, the media asset server 3 generates index information for representing an advertisement data address according to the request information, and transmits the index information to the proxy server 2; wherein, the index information can carry a programme index (PID), a channel index (CID), etc., can distinguish addresses of different versions (e.g., high definition, standard definition and smooth versions) of advertisements, and can also carry information about whether the advertisement is paid, etc. to allow the client to make an appropriate choice;

Step S22, the proxy server 2 transmits the index information to the advertisement server 4; wherein, in the embodiment, advertisement data resources are stored in the advertisement server 4;

Step S31, the advertisement server 4 extracts advertisement data according to the index information, and transmits the advertisement data to the proxy server 2; wherein, extracting advertisement data according to the index information specifically comprises: the advertisement server 4 selectively extracts advertisement data according to one or more of parameters carried in the index information, for example, points to the address of the advertisement data according to the programme index (PID), the channel index (CID), etc. and extracts a specific high definition, standard definition or smooth version according to version information; and

Step S23, the proxy server 2 transmits the advertisement data to the client 1.

In the advertisement data transmission system disclosed in the embodiment, because the client transmits the request information for representing a request for acquiring the advertisement data, and the index information through the proxy service and then receives the advertisement data transmitted by the proxy service when the client has the network connection with the proxy server, as compared with serial data interaction that the client transmits the request information and the index information to the media asset server and the advertisement server respectively, the time consumption for requesting an advertisement is shortened and the transmission efficiency of the advertisement data is increased.

In an optional embodiment, the proxy server 2 performs data interaction with the media asset server 3 and the advertisement server 4 through a local area network. Because data interaction is performed through the local area network without passing through a router, data interaction can be completed more quickly and the efficiency of data interaction is increased.

In order to prevent a situation that advertisement data cannot be transmitted in case of communication failure between the client 1 and the proxy server 2, in an optional embodiment, the client 1 starts system broadcast for monitoring whether the network connection with the proxy server 2 is normal. Specifically, the client 1 transmits a system broadcast message, and the proxy server 2 returns a system broadcast response message to the client 1 after receiving the system broadcast message; and if the client 1 does not receive the system broadcast response message returned by the proxy server within a preset duration, a traditional data transmission manner is used, i.e., the client 1 transmits request information for representing a request for acquiring advertisement data to the media asset server 3; the media asset server 3 generates index information for representing an advertisement data address according to the request information, and transmits the index information to the client 1; the client 1 transmits the index information to the advertisement server 4; and the advertisement server 4 extracts advertisement data according to the index information, and transmits the advertisement data to the client 1. In a specific embodiment, the preset duration can be determined according to experience.

In an optional embodiment, the proxy server communicates with the media asset server and the advertisement server through a local area network, thereby further increasing the data interaction efficiency.

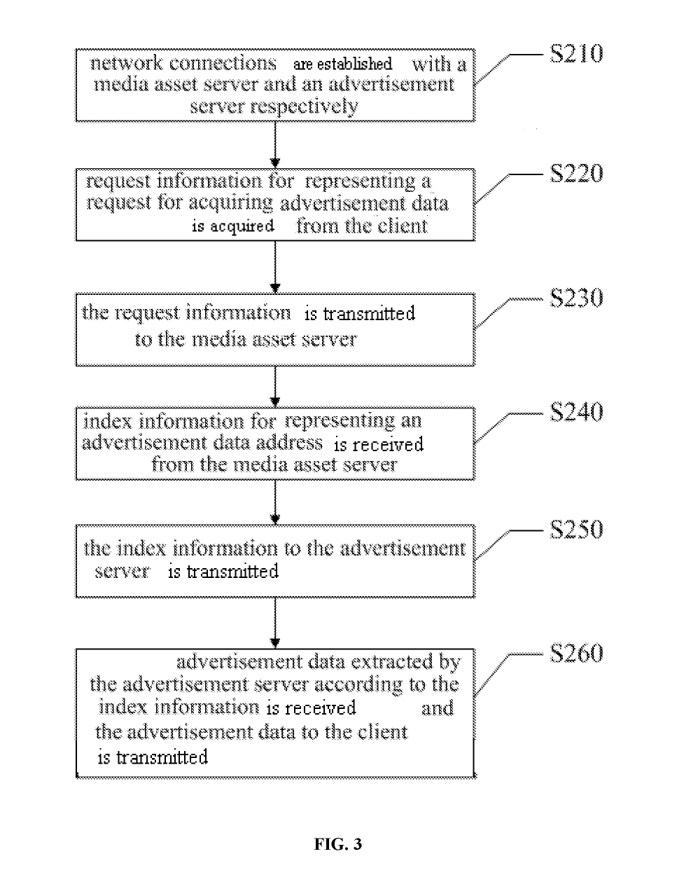

The embodiment discloses an advertisement data transmission method, used for a proxy server side. See FIG. 3, which shows the flow chart of the data transmission method that specifically comprises the following steps:

Step S210, network connections are established with a media asset server and an advertisement server respectively; wherein, in the embodiment, a proxy server for the media asset server and the advertisement server is established, and communication parameters with the media asset server and the advertisement server are configured for realizing communication with the media asset server and the advertisement server; in an optional embodiment, the communication parameters are local area network communication parameters for the convenience of realizing faster communication with each other;

Step S220, request information for representing a request for acquiring advertisement data is acquired from a client;

wherein, the request information can come from an application of a client 1; when an audience user runs a game application or opens a certain web page, the application transmits the request information, wherein the request information can carry one or more of advertisement parameters of a user identifier, a business provider identifier or a client identifier, terminal information (such as the type, etc.), context data, an advertisement provider, an advertisement position identifier, an advertisement size, an advertisement dimension, etc.;

Step S230, the request information to the media asset server is transmitted;

wherein, the media asset server generates index information for representing an advertisement data address according to the request information.

Step S240, the index information for representing the advertisement data address from the media asset server is received;

wherein, the index information can carry a programme index (PID), a channel index (CID), etc., can distinguish addresses of different versions (e.g., high definition, standard definition and smooth versions) of advertisements, and can also carry information about whether the advertisement is paid, etc. to allow the client to make an appropriate choice according to the information;

Step S250, the index information to the advertisement server is transmitted;

wherein, advertisement data is stored in the advertisement server, and can be classified by the version as a high definition version, a standard definition version, a smooth version, etc.; and different classes or different versions of advertisement data are respectively stored in different addresses of the advertisement server; the advertisement server can selectively extract the advertisement data according to one or more parameters carried in the index information, for example, can point to the address of the advertisement data according to the programme index (PID), the channel index (CID), etc.; and

Step S260, the advertisement data extracted by the advertisement server according to the index information is received, and transmitting the advertisement data to the client.

In this way, the request for the advertisement data and the transmission of the advertisement data can be completed through the proxy server.

The embodiment further discloses an advertisement data transmission device, used for a proxy server side. See FIG. 4, the advertisement data transmission device comprises: a configuration unit 210, a request information acquisition unit 220, a request information transmission unit 230, an index information reception unit 240, an index information transmission unit 250 and a data transmission unit 260, wherein:

the configuration unit 210 is used for establishing network connections with a media asset server and an advertisement server respectively; the request information acquisition unit 220 is used for acquiring request information for representing a request for acquiring advertisement data from a client; the request information transmission unit 230 is used for transmitting the request information to the media asset server; the index information reception unit 240 is used for receiving index information for representing an advertisement data address from the media asset server; the index information transmission unit 250 is used for transmitting the index information to the advertisement server; and the data transmission unit 260 is used for receiving advertisement data extracted by the advertisement server according to the index information, and transmitting the advertisement data to the client.

In the advertisement data transmission method and device provided in the embodiment, because the client transmits the request information for representing a request for acquiring the advertisement data, and the index information through the proxy service and then receives the advertisement data transmitted by the proxy service, as compared with serial data interaction that the client transmits the request information and the index information to the media asset server and the advertisement server respectively, the time consumption for requesting an advertisement is shortened and the transmission efficiency of the advertisement data is increased.

In addition, the proxy server communicates with the media asset server and the advertisement server through a local area network, thereby further increasing the data interaction efficiency.

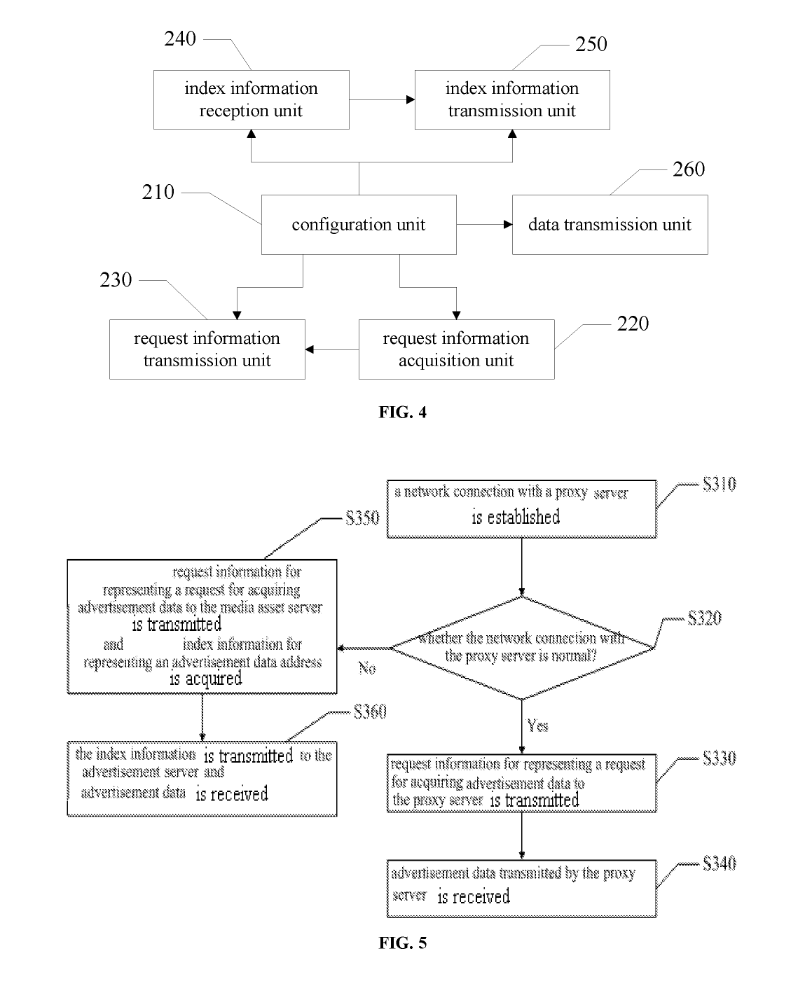

The embodiment discloses an advertisement data transmission method, used for a client. See FIG. 5, which shows the flow chart of the data transmission method that specifically comprises the following steps:

Step S310, establishing a network connection with a proxy server;

wherein, in the embodiment, the network connection can be a wireless network connection, e.g., WiFi, optical communication connection, etc., or a mobile data network, e.g., CMCC, China Telecom, China Unicom, etc.; of course, in other regions, the network connection can also be a mobile data network of other places;

Step S320, starting system broadcast for monitoring whether the network connection with the proxy server is normal;

wherein, specifically, a system broadcast message can be transmitted to the proxy server and a system broadcast response message returned by the proxy server is received; if the system broadcast response message returned by the proxy server is received within a preset duration, then it indicates that the monitoring result is normal, wherein the preset duration can be determined according to experience, and the following steps are executed:

Step S330, transmitting request information for representing a request for acquiring advertisement data to the proxy server; wherein, when an audience user runs a game application or opens a certain web page, the application transmits the request information, wherein the request information can carry one or more of advertisement parameters of a user identifier, a business provider identifier or a client identifier, terminal information (such as the type, etc.), context data, an advertisement provider, an advertisement position identifier, an advertisement size, an advertisement dimension, etc.;

Step S340, receiving advertisement data transmitted by the proxy server;

if the system broadcast response message returned by the proxy server is not received within a preset duration in Step S320, then it indicates that the monitoring result is abnormal and the following steps are executed:

Step S350, transmitting request information for representing a request for acquiring advertisement data to the media asset server, and acquiring index information for representing an advertisement data address; and

Step S360, transmitting the index information to the advertisement server, and receiving advertisement data; wherein, after the index information is transmitted to the advertisement server, the advertisement server can extract advertisement data according to the index information, and transmit the advertisement data to the client, so that the advertisement data is received.

It should be noted that in a specific embodiment, Step S310, Step S330 and Step S340 can be directly executed without executing Step S320.

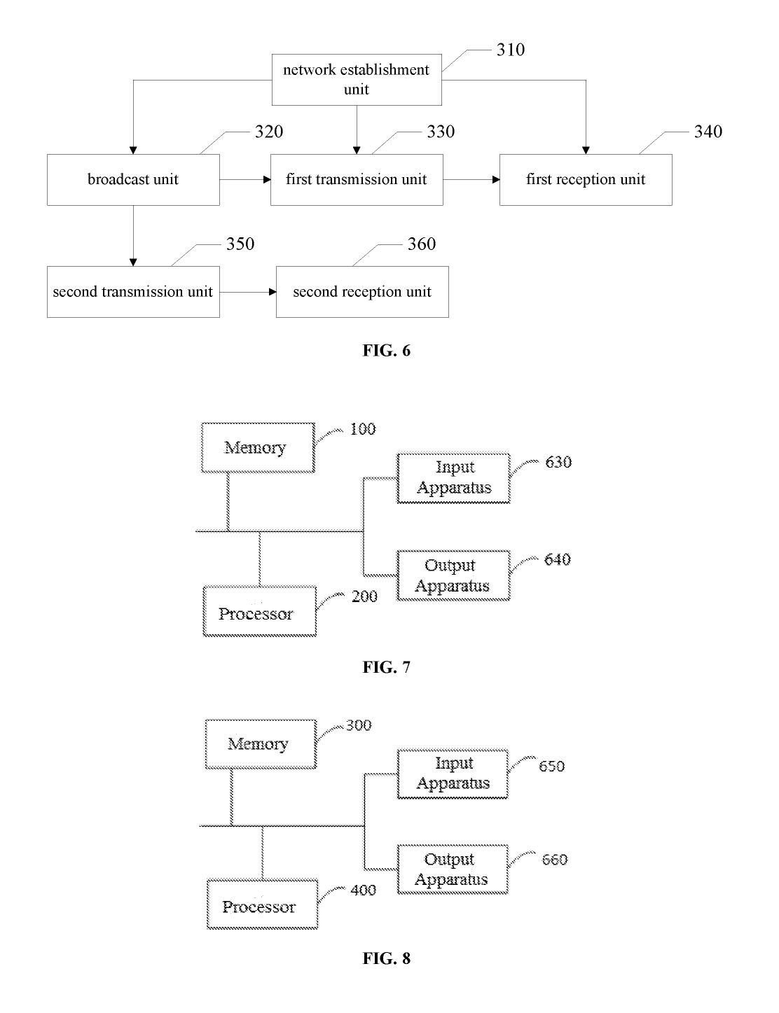

The embodiment discloses an advertisement data transmission device, used for a client. See FIG. 6, the advertisement data transmission device comprises: a network establishment unit 310, a broadcast unit 320, a first transmission unit 330, a first reception unit 340, a second transmission unit 350 and a second reception unit 360, wherein:

the network establishment unit 310 is used for establishing a network connection with a proxy server; the broadcast unit 320 is used for starting system broadcast for monitoring whether the network connection with the proxy server is normal; the first transmission unit 330 is used for transmitting request information for representing a request for acquiring advertisement data to the proxy server; the first reception unit 340 is used for receiving advertisement data transmitted by the proxy server; the second transmission unit 350 is used for transmitting request information for representing a request for acquiring advertisement data to a media asset server, and acquiring index information for representing an advertisement data address; and the second reception unit 360 is used for transmitting the index information to an advertisement server, and receiving advertisement data.

In the advertisement data transmission method and device disclosed in the embodiment, the client broadcasts and monitors whether the network connection with the proxy server is normal, and if normal, the advertisement request is transmitted and the advertisement data is received through the proxy server, therefore, the transmission efficiency of the advertisement data is increased; if abnormal, the request information for representing a request for acquiring the advertisement data is directly transmitted to the media asset server, and then the advertisement data is received, thereby ensuring normal transmission of the advertisement data.

The embodiment provides a non-transitory computer-readable storage medium, used for a proxy server side, storing computer executable instructions that can perform the advertisement data transmission method applied to a proxy server side of any one of the above-mentioned method embodiments.

The non-transitory computer-readable storage medium storing computer executable instructions that, when executed by an electronic device, cause the electronic device to: establish network connections with a media asset server and an advertisement server respectively; acquire request information for representing a request for acquiring advertisement data from the client; transmit the request information to the media asset server; receive index information for representing an advertisement data address from the media asset server; transmit the index information to the advertisement server; and receive advertisement data extracted by the advertisement server according to the index information, and transmit the advertisement data to the client.

The non-transitory computer-readable storage medium, wherein, the communication parameters are local area network communication parameters.

FIG. 7 is a schematic diagram of the hardware configuration of the electronic device provided by the embodiments of the disclosure, which performs the advertisement data transmission method applied to a proxy server side. As shown in FIG. 7, the electronic device comprises: one or more processors 200 and a memory 100, wherein one processor 200 is shown in FIG. 7 as an example. The electronic device that performs the advertisement data transmission method applied to the proxy server side further comprises an input apparatus 630 and an output apparatus 640.

The processor 200, the memory 100, the input apparatus 630 and the output apparatus 640 may be connected via a bus line or other means, wherein connection via a bus line is shown in FIG. 7 as an example.

The memory 100 is a non-transitory computer-readable storage medium that can be used to store non-transitory software programs, non-transitory computer-executable programs and modules, such as the program instructions/modules corresponding to the advertisement data transmission method applied to the proxy server side of the embodiments of the disclosure (e.g. configuration unit 210, request information acquisition unit 220, request information transmission unit 230, index information reception unit 240, index information transmission unit 250 and data transmission unit 260 shown in the FIG. 4). The processor 200 executes the non-transitory software programs, instructions and modules stored in the memory 100 so as to perform various function application and data processing of the server, thereby implementing the advertisement data transmission method applied to the proxy server side of the above-mentioned method embodiments.

The memory 100 comprises a program storage area and a data storage area, wherein, the program storage area can store an operation system and application programs required for at least one function; the data storage area can store data generated by use of the device for generating multimedia photos. Furthermore, the memory 100 may comprise a high-speed random access memory, and may also comprise a non-volatile memory, e.g. at least one magnetic disk memory unit, flash memory unit, or other non-volatile solid-state memory unit. In some embodiments, optionally, the memory 100 comprises a remote memory accessed by the processor 200, and the remote memory is connected to the advertisement data transmission device applied to the proxy server side via network connection. Examples of the aforementioned network comprise but not limited to internet, intranet, LAN, GSM, and their combinations.

The input apparatus 630 receives digit or character information, so as to generate signal input related to the user configuration and function control of the advertisement data transmission device applied to the proxy server side. The output apparatus 640 comprises display devices such as a display screen.

The one or more modules are stored in the memory 100 and, when executed by the one or more processors 200, perform the advertisement data transmission method applied to a proxy server side of any one of the above-mentioned method embodiments.

The above-mentioned product can perform the method provided by the embodiments of the disclosure and have function modules as well as beneficial effects corresponding to the method. Those technical details not described in this embodiment can be known by referring to the method provided by the embodiments of the disclosure.

The electronic device of the embodiments of the disclosure can exist in many forms, comprising but not limited to:

(1) Mobile communication devices: The characteristic of this type of device is having a mobile communication function with a main goal of enabling voice and data communication. This type of terminal device comprises: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device comprises: PDA, MID, UMPC devices, such as iPad.

(3) Portable entertainment devices: This type of device is able to display and play multimedia contents. This type of terminal device comprises: audio and video players (such as iPod), handheld game players, electronic books, intelligent toys, and portable GPS devices.

(4) Servers: devices providing computing service. The structure of a server comprises a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The embodiment provides a non-transitory computer-readable storage medium, used for a client, storing computer executable instructions that can perform the advertisement data transmission method applied to a client of any one of the above-mentioned method embodiments.

The non-transitory computer-readable storage medium storing computer executable instructions that, when executed by an electronic device, cause the electronic device to: establish a network connection with the proxy server; transmit request information for representing a request for acquiring advertisement data to the proxy server; and receive advertisement data transmitted by the proxy server.

The non-transitory computer-readable storage, wherein comprising the steps of transmitting a system broadcast message to the proxy server for monitoring whether the network connection with the proxy server is normal; if a system broadcast response message returned by the proxy server is not received within a preset duration, then transmitting request information for representing a request for acquiring advertisement data to a media asset server, and acquiring index information for representing an advertisement data address; and transmitting the index information to an advertisement server and receiving advertisement data.

FIG. 8 is a schematic diagram of the hardware configuration of the electronic device provided by the embodiments of the disclosure, which performs the advertisement data transmission method applied to a client. As shown in FIG. 8, the electronic device comprises: one or more processors 400 and a memory 300, wherein one processor 400 is shown in FIG. 8 as an example. The electronic device that performs the advertisement data transmission method applied to the client further comprises an input apparatus 650 and an output apparatus 660.

The processor 400, the memory 300, the input apparatus 650 and the output apparatus 660 may be connected via a bus line or other means, wherein connection via a bus line is shown in FIG. 8 as an example.

The memory 300 is a non-transitory computer-readable storage medium that can be used to store non-transitory software programs, non-transitory computer-executable programs and modules, such as the program instructions/modules corresponding to the advertisement data transmission method applied to the client of the embodiments of the disclosure (e.g. network establishment unit 310, broadcast unit 320, first transmission unit 330, first reception unit 340, second transmission unit 350 and second reception unit 360 shown in the FIG. 6). The processor 400 executes the non-transitory software programs, instructions and modules stored in the memory 300 so as to perform various function application and data processing of the server, thereby implementing the advertisement data transmission method applied to the client of the above-mentioned method embodiments.

The memory 300 comprises a program storage area and a data storage area, wherein, the program storage area can store an operation system and application programs required for at least one function; the data storage area can store data generated by use of the device for generating multimedia photos. Furthermore, the memory 300 may comprise a high-speed random access memory, and may also comprise a non-volatile memory, e.g. at least one magnetic disk memory unit, flash memory unit, or other non-volatile solid-state memory unit. In some embodiments, optionally, the memory 300 comprises a remote memory accessed by the processor 400, and the remote memory is connected to the advertisement data transmission device applied to the client via network connection. Examples of the aforementioned network comprise but not limited to internet, intranet, LAN, GSM, and their combinations.

The input apparatus 650 receives digit or character information, so as to generate signal input related to the user configuration and function control of the advertisement data transmission device applied to the client. The output apparatus 660 comprises display devices such as a display screen.

The one or more modules are stored in the memory 300 and, when executed by the one or more processors 400, perform the advertisement data transmission method applied to a client of any one of the above-mentioned method embodiments.

The above-mentioned product can perform the method provided by the embodiments of the disclosure and have function modules as well as beneficial effects corresponding to the method. Those technical details not described in this embodiment can be known by referring to the method provided by the embodiments of the disclosure.

The electronic device of the embodiments of the disclosure can exist in many forms, comprising but not limited to:

(1) Mobile communication devices: The characteristic of this type of device is having a mobile communication function with a main goal of enabling voice and data communication. This type of terminal device comprises: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device comprises: PDA, MID, UMPC devices, such as iPad.

(3) Portable entertainment devices: This type of device is able to display and play multimedia contents. This type of terminal device comprises: audio and video players (such as iPod), handheld game players, electronic books, intelligent toys, and portable GPS devices.

(4) Servers: devices providing computing service. The structure of a server comprises a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may comprise a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the disclosure, without restricting the technical scheme of the disclosure. Although detailed description of the disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the disclosure.

What is claimed is:

1. An advertisement data transmission method, used for a proxy server side, comprising:
establishing network connections with a media asset server and an advertisement server respectively;
acquiring request information for representing a request for acquiring advertisement data from the client;
transmitting the request information to the media asset server;
receiving index information for representing an advertisement data address from the media asset server;
transmitting the index information to the advertisement server; and
receiving advertisement data extracted by the advertisement server according to the index information, and transmitting the advertisement data to the client.

2. The advertisement data transmission method of claim 1, wherein communication parameters are local area network communication parameters.

3. An electronic device, comprising:
at least one processor; and a memory communicably connected with the at least one processor for storing instructions executable by the at least one processor, wherein execution of the instructions by the at least one processor causes the at least one processor to:
establish network connections with a media asset server and an advertisement server respectively;
acquire request information for representing a request for acquiring advertisement data from the client;
transmit the request information to the media asset server;
receive index information for representing an advertisement data address from the media asset server;
transmit the index information to the advertisement server; and
receive advertisement data extracted by the advertisement server according to the index information, and transmit the advertisement data to the client.

4. The electronic device of claim 3, wherein communication parameters are local area network communication parameters.

5. A non-transitory computer-readable storage medium storing computer executable instructions that, when executed by an electronic device, cause the electronic device to:
establish network connections with a media asset server and an advertisement server respectively;
acquire request information for representing a request for acquiring advertisement data from the client; transmit the request information to the media asset server;
receive index information for representing an advertisement data address from the media asset server;
transmit the index information to the advertisement server; and
receive advertisement data extracted by the advertisement server according to the index information, and transmit the advertisement data to the client.

6. The non-transitory computer-readable storage medium of claim 5, wherein communication parameters are local area network communication parameters.
